(19) United States
(12) Patent Application Publication
(10) Pub. No.: US 2026/0129293 A1
(43) Pub. Date: May 7, 2026

(54) FOCUS CONTROL DEVICE, FOCUS CONTROL METHOD, AND PROGRAM

(71) Applicant: FUJIFILM Corporation, Tokyo (JP)

(72) Inventor: Hideaki KOKUBUN, Saitama (JP)

(73) Assignee: FUJIFILM Corporation, Tokyo (JP)

(21) Appl. No.: 19/325,538

(22) Filed: Sep. 11, 2025

(30) Foreign Application Priority Data
Sep. 27, 2024 (JP) 2024-169518

(51) Int. Cl. H04N 23/67; H04N 25/531; H04N 25/704

(52) U.S. Cl. CPC H04N 23/675; H04N 25/531; H04N 25/704

(57) ABSTRACT

A focus control device according to the present disclosure includes a processor, in which the processor is configured to execute, in a case in which a portion of an imaging element corresponding to a specific region in a captured image is exposed, at least one of first control of making a focus driving speed constant or second control of limiting the focus driving speed to be equal to or less than a predetermined speed.

### CROSS-REFERENCE TO RELATED APPLICATIONS

The present application claims priority under 35 U.S.C. § 119 to Japanese Patent Application No. 2024-169518, filed on Sep. 27, 2024. The above application is hereby expressly incorporated by reference, in its entirety, into the present application.

### BACKGROUND

### 1. Technical Field

The technology of the present disclosure relates to a focus control device, a focus control method, and a program.

### 2. Description of the Related Art

A focus control device disclosed in JP2006-243527A has a sequence of setting a partial region in one imaging screen as a detection region, obtaining an evaluation value by performing detection only for an exposure period corresponding to the detection region from a CMOS sensor exposed by a rolling-shutter method, and moving a focus lens to a lens position for acquiring a next evaluation value sample. In this case, since the detection region is the partial region of one imaging screen, it is possible to ensure a long time for a pause period for each detection period for every two horizontal synchronization periods. By setting a timing to move the focus lens in this pause period, it is possible to execute the evaluation value acquisition and the focus lens movement at the timing for each horizontal synchronization period.

An imaging system disclosed in JP2009-516448A acquires an image sequence comprising at least two images in which at least one image is used as a measurement image and at least one image is used as a final image, and determines an exposure time for the measurement image and an exposure time for the final image. A non-exposure time can be determined from the exposure time for the measurement image and the exposure time for the final image. As a result, an imaging optical system can be adjusted during the non-exposure time.

An imaging device disclosed in JP2013-106113A is an imaging device including an imaging unit having a focus lens with a variable focal length, an exposure controller that realizes a plurality of imaging operations with different sensitivities, a camera signal processing unit that generates a video signal and a focal point evaluation value indicating a degree of focusing, a video synthesis unit that synthesizes a plurality of video signals with different sensitivities generated by the camera signal processing unit and outputs the synthesized video signal, and a focus controller that controls the focus lens of the imaging unit based on the focal point evaluation value output by the camera signal processing unit, to adjust the focal length, in which the camera signal processing unit generates the focal point evaluation value for each of a plurality of imaging signals with different sensitivities output by the imaging unit, and the focus controller controls the focus lens based on the focal point evaluation value corresponding to each of the plurality of imaging operations with different sensitivities of the imaging unit.

### SUMMARY

The technology of the present disclosure provides a focus control device, a focus control method, and a program that can suppress image quality deterioration due to focus driving in a case in which a plurality of imaging operations are continuously performed.

In order to achieve the above-described object, the present disclosure provides a focus control device comprising: a processor, in which the processor is configured to execute, in a case in which a portion of an imaging element corresponding to a specific region in a captured image is exposed, at least one of first control of making a focus driving speed constant or second control of limiting the focus driving speed to be equal to or less than a predetermined speed.

It is preferable that the imaging element undergo exposure using a rolling-shutter method.

It is preferable that the imaging element undergo the exposure a plurality of times in response to one imaging instruction.

It is preferable that the processor be configured to perform focus driving over a period during which the exposure is performed the plurality of times.

It is preferable that the processor be configured to acquire a focus driving amount, and execute the second control in a case in which a change amount of a depth of field corresponding to the acquired focus driving amount is greater than a predetermined value.

It is preferable that the predetermined speed be a focus driving speed in a case in which focus driving is performed by a focus driving amount corresponding to the predetermined value.

It is preferable that the imaging element include a plurality of phase-difference detection pixels, and the processor be configured to calculate the focus driving amount based on a defocus amount obtained based on output values of the plurality of phase-difference detection pixels.

It is preferable that the processor be configured to execute, in addition to the first control or the second control, third control of performing focus driving in a non-exposure period obtained by shifting an exposure timing.

It is preferable that the processor be configured to perform, in the third control, the focus driving at a focus driving speed greater than the predetermined speed.

It is preferable that the specific region be a focus target region.

The specific region may be a region including a specific subject.

The present disclosure provides a focus control method executed by a processor, comprising: executing, in a case in which a portion of an imaging element corresponding to a specific region in a captured image is exposed, at least one of first control of making a focus driving speed constant or second control of limiting the focus driving speed to be equal to or less than a predetermined speed.

The present disclosure provides a program causing a processor to execute a process comprising: executing, in a case in which a portion of an imaging element corresponding to a specific region in a captured image is exposed, at least one of first control of making a focus driving speed constant or second control of limiting the focus driving speed to be equal to or less than a predetermined speed.

### BRIEF DESCRIPTION OF THE DRAWINGS

Exemplary embodiments according to the technique of the present disclosure will be described in detail based on the following figures, wherein:

FIG. 1 is a diagram showing an example of a configuration of an imaging device,

FIG. 2 is a diagram showing an example of a light-receiving surface of an imaging element,

FIG. 3 is a block diagram showing an example of a functional configuration of a processor,

FIG. 4 is a diagram conceptually showing an example of distance measurement processing performed by a distance measurement unit,

FIG. 5 is a flowchart showing an example of a flow of focus control,

FIG. 6 is a diagram showing an example of various timings related to the focus control,

FIG. 7 is a flowchart showing an example of a flow of focus control according to a second embodiment,

FIG. 8 is a flowchart showing an example of a flow of processing of determining a limit speed,

FIG. 9 is a diagram showing an example of a change amount of a depth of field in a case in which a subject distance is short,

FIG. 10 is a diagram showing an example of a change amount of the depth of field in a case in which the subject distance is large,

FIG. 11 is a diagram showing an example of various timings related to the focus control according to the second embodiment, and

FIG. 12 is a diagram showing an example of various timings in third control.

### DETAILED DESCRIPTION

An example of embodiments of the technology of the present disclosure will be described with reference to the accompanying drawings.

First, the terms used hereinafter will be described.

In the following description, “AF” is an abbreviation for “auto focus”. “MF” is an abbreviation for “manual focus”. “IC” is an abbreviation for “integrated circuit”. “CPU” is an abbreviation for “central processing unit”. “ROM” is an abbreviation for “read-only memory”. “RAM” is an abbreviation for “random-access memory”. “CMOS” is an abbreviation for “complementary metal-oxide-semiconductor”. “OVF” is an abbreviation for “optical view finder”. “EVF” is an abbreviation for “electronic view finder”.

The technology of the present disclosure will be described by using a lens-interchangeable digital camera as an example of one embodiment of an imaging device. The technology of the present disclosure is not limited to the lens-interchangeable type, and can be applied to a lens-integrated digital camera.

### First Embodiment

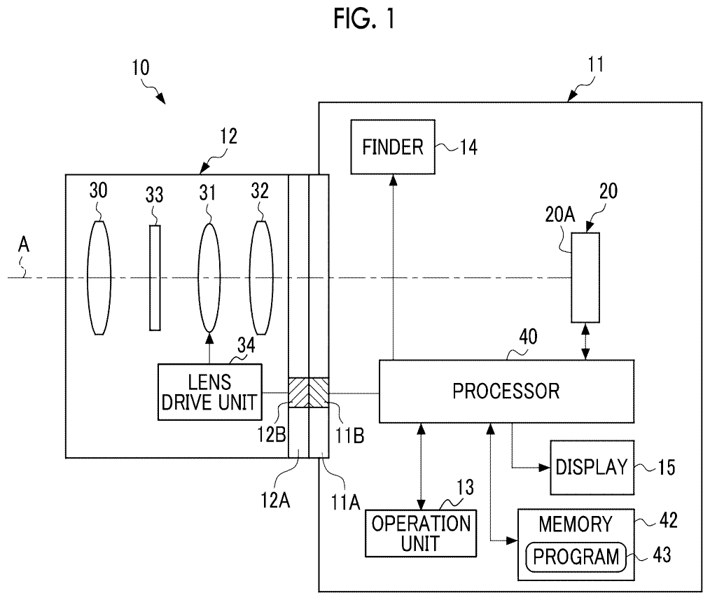

FIG. 1 shows an example of a configuration of an imaging device 10. The imaging device 10 is a lens-interchangeable digital camera. The imaging device 10 includes a body 11 and an imaging lens 12 that is interchangeably mounted in the body 11 and that includes a focus lens 31. The imaging lens 12 is attached to a front surface side of the body 11 via a camera-side mount 11A and a lens-side mount 12A.

An operation unit 13 including a dial, a release button, and the like is provided in the body 11. For example, a still image capturing mode, a continuous imaging mode, a video capturing mode, and an image display mode are included as operation modes of the imaging device 10. The operation unit 13 is operated by a user in a case of setting the operation mode. In addition, the operation unit 13 is operated by the user in a case of starting the execution of the still image capturing, the continuous imaging, or the video capturing.

In addition, the operation unit 13 is operated by the user in a case in which a focus mode is selected. An AF mode and an MF mode are included in the focus mode. The AF mode is a mode in which focus control is automatically performed on a focus target region (hereinafter, referred to as an AF area) within an angle of view. The user can use the operation unit 13 to set the AF area within the angle of view. The MF mode is a mode in which the user manually performs the focus control by operating a focus ring (not shown). In addition, the imaging device 10 may be configured to allow the user to set the AF area via a display 15 having a touch panel function or a finder 14 having a visual line detection function.

In addition, the body 11 is provided with the finder 14. Here, the finder 14 is a Hybrid Viewfinder (registered trademark). The Hybrid Viewfinder refers to, for example, a finder in which an optical view finder (hereinafter, referred to as “OVF”) and an electronic view finder (hereinafter, referred to as “EVF”) are selectively used. The user can observe, through a finder eyepiece portion (not shown), an optical image of the subject or a live view image displayed by the finder 14.

In addition, the display 15 is provided on a rear surface side of the body 11. An image based on image data obtained by imaging, various menu screens, and the like are displayed on the display 15. The user can also observe the live view image displayed on the display 15 instead of the finder 14.

The body 11 and the imaging lens 12 are electrically connected to each other through contact between an electrical contact 11B provided on the camera-side mount 11A and an electrical contact 12B provided on the lens-side mount 12A.

The imaging lens 12 includes an objective lens 30, a focus lens 31, a rear end lens 32, and a stop 33. The members are arranged in the order of the objective lens 30, the stop 33, the focus lens 31, and the rear end lens 32 from an objective side along an optical axis A of the imaging lens 12. The objective lens 30, the focus lens 31, and the rear end lens 32 constitute an optical system. The type, the number, and the arrangement order of lenses constituting the optical system are not limited to the example shown in FIG. 1.

In addition, the imaging lens 12 includes a lens drive unit 34. For example, the lens drive unit 34 includes a stepping motor that moves the focus lens 31 in a direction of the optical axis A, and a driver that supplies a pulse to the stepping motor. The stepping motor moves the focus lens 31 in accordance with the pulse supplied from the driver.

The lens drive unit 34 is electrically connected to a processor 40 in the body 11. The lens drive unit 34 drives the focus lens 31 based on a control signal transmitted from the processor 40. The lens drive unit 34 drives the focus lens 31 based on the control signal for the focus control transmitted from the processor 40, in order to adjust a position of the focus lens 31.

In addition, an imaging element 20, the processor 40, and a memory 42 are provided inside the body 11. The operations of the imaging element 20, the memory 42, the operation unit 13, the finder 14, and the display 15 are controlled by the processor 40.

The processor 40 includes, for example, a CPU, a RAM, and a ROM. In such a case, the processor 40 executes various types of processing based on a program 43 stored in the memory 42. In addition, the processor 40 may be configured by an assembly of a plurality of IC chips.

The imaging element 20 is, for example, a CMOS image sensor. The imaging element 20 is disposed such that the optical axis A is perpendicular to a light-receiving surface 20A and the optical axis A is located at the center of the light-receiving surface 20A. Light, which has passed through the imaging lens 12, is incident on the light-receiving surface 20A. A plurality of pixels for generating imaging signals through photoelectric conversion are formed on the light-receiving surface 20A. The imaging element 20 generates captured image data PD (hereinafter, simply referred to as a captured image PD) by photoelectrically converting light incident on each pixel, and outputs the generated captured image PD.

In addition, a color filter array of a Bayer array is disposed on the light-receiving surface 20A of the imaging element 20, and any one of red (R), green (G), or blue (B) color filter is disposed to face each pixel. It should be noted that some of the plurality of pixels arranged on the light-receiving surface 20A of the imaging element 20 are phase-difference detection pixels that output phase-difference detection signals.

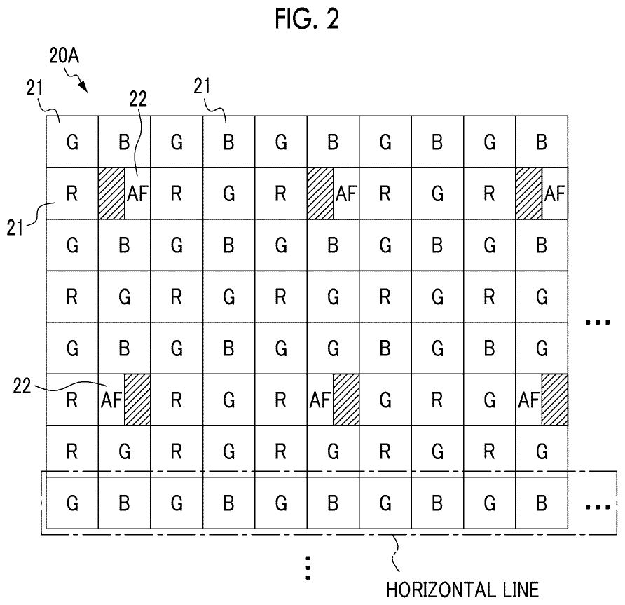

FIG. 2 shows an example of the light-receiving surface 20A of the imaging element 20. A plurality of imaging pixels 21 and a plurality of phase-difference detection pixels 22 are arranged on the light-receiving surface 20A. The imaging pixels 21 are pixels in which the color filters described are disposed. The imaging pixel 21 receives a luminous flux that passes through the entire region of an exit pupil of the imaging optical system. The phase-difference detection pixel 22 receives a luminous flux that passes through a region of the half of the exit pupil of the imaging optical system. In the example shown in FIG. 2, some of the G pixels, which are diagonally disposed, are replaced with the phase-difference detection pixels 22 in the Bayer array. The phase-difference detection pixels 22 are disposed at regular intervals in a vertical direction and a horizontal direction on the light-receiving surface 20A. The phase-difference detection pixels 22 are classified into first phase-difference detection pixels that receive the luminous flux that passes through the region of the half of the exit pupil and second phase-difference detection pixels that receive the luminous flux that passes through a region of the other half of the exit pupil.

The plurality of imaging pixels 21 output the imaging signals for generating an image of the subject. The plurality of phase-difference detection pixels 22 output the phase-difference detection signals. The captured image PD output from the imaging element 20 includes the imaging signal and the phase-difference detection signal. The phase-difference detection signal corresponds to an “output value of the phase-difference detection pixel” according to the technology of the present disclosure.

The imaging element 20 has an electronic shutter function, and undergoes exposure using a rolling-shutter method. In the rolling-shutter method, the pixels arranged in a matrix form as shown in FIG. 2 are scanned in line order. For example, one horizontal line is selected, and the pixel values are read out in sequence from this horizontal line. The pixels whose pixel values have been read out are reset, and the exposure is restarted. Subsequently, the next horizontal line adjacent to the above-described horizontal line is selected, and reading out and resetting of the pixel value are performed in the same manner. That is, the rolling-shutter method is a “line exposure sequential reading method” in which the exposure is performed for each horizontal line. In the rolling-shutter method, a period from resetting for each horizontal line to reading out of the pixel value is an exposure period, and the exposure period is shifted by one horizontal line.

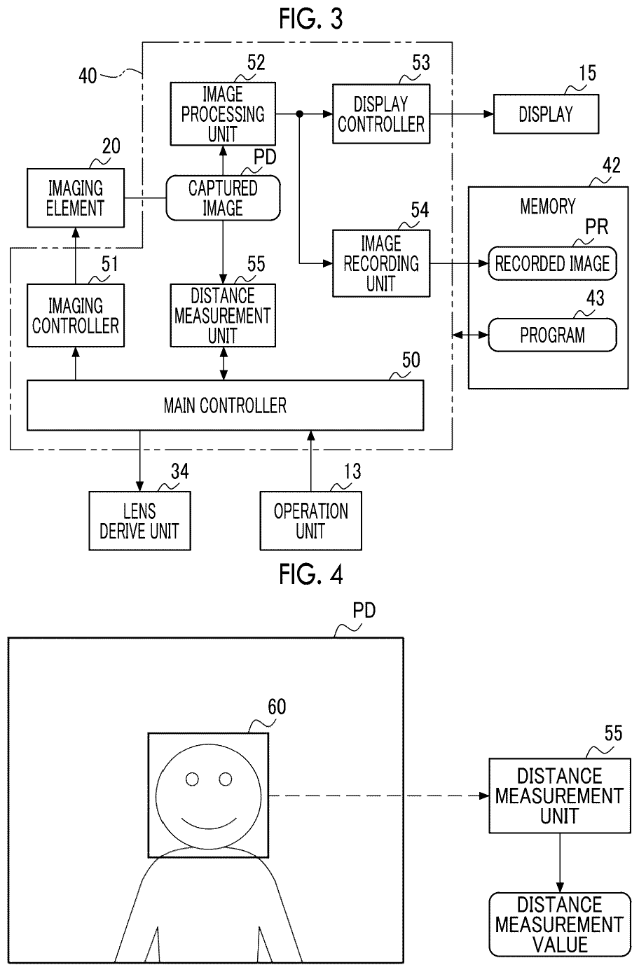

FIG. 3 shows an example of a functional configuration of the processor 40. The processor 40 executes processing in accordance with the program 43 stored in the memory 42, to implement various functional units. As shown in FIG. 3, for example, the processor 40 implements a main controller 50, an imaging controller 51, an image processing unit 52, a display controller 53, an image recording unit 54, and a distance measurement unit 55. The distance measurement unit 55 operates in a case in which the AF mode is set.

The main controller 50 comprehensively controls operations of the imaging device 10 based on instruction signals input from the operation unit 13. The imaging controller 51 controls the imaging element 20 to execute imaging processing of causing the imaging element 20 to generate the captured image PD. The imaging controller 51 drives the imaging element 20 in the still image capturing mode, the continuous imaging mode, or the video capturing mode. The imaging element 20 outputs the captured image PD generated by performing imaging via the imaging lens 12. The captured image PD, which is output from the imaging element 20, is supplied to the image processing unit 52 and the distance measurement unit 55.

The image processing unit 52 acquires the captured image PD output from the imaging element 20, and performs image processing including white balance adjustment, gamma correction processing, and the like on the captured image PD.

The display controller 53 displays, on the display 15, a live view image based on the captured image PD obtained by performing the image processing via the image processing unit 52. The image recording unit 54 records, as a recorded image PR, the captured image PD that is obtained by performing the image processing via the image processing unit 52 in the memory 42 in a case in which the release button is fully pressed.

The distance measurement unit 55 obtains a distance from the imaging element 20 to the subject in the AF area, and outputs a distance measurement value. Specifically, the distance measurement unit 55 acquires the plurality of phase-difference detection signals from the AF area of the captured image PD output from the imaging element 20, and outputs a distance obtained based on the plurality of acquired phase-difference detection signals as the distance measurement value. The distance measurement value corresponds to a defocus amount representing an amount of shift from an in-focus position of the focus lens 31.

In a case in which a subject detection function is provided, the distance measurement unit 55 may use a region including a specific subject detected by the subject detection as the AF area, and obtains a distance to the subject included in the AF area to output the distance measurement value. A type of the subject detected by the subject detection is, for example, a human face.

The main controller 50 moves the focus lens 31 via the lens drive unit 34 based on the distance measurement value output from the distance measurement unit 55, to bring the subject included in the AF area into an in-focus state. As described above, in the present embodiment, the main controller 50 performs the focus control using the phase difference detection method. The main controller 50 is an example of a “focus control device” according to the technology of the present disclosure. Hereinafter, moving the focus lens 31 will be referred to as “focus driving”.

FIG. 4 conceptually shows an example of distance measurement processing performed by the distance measurement unit 55. In FIG. 4, reference numeral 60 denotes the AF area. The AF area 60 has, for example, a rectangular shape. The distance measurement unit 55 acquires the plurality of phase-difference detection signals from the AF area 60 to obtain the distance measurement value, and then outputs the distance measurement value. The AF area 60 is an example of a “specific region” according to the technology of the present disclosure.

In a case in which a plurality of imaging operations, such as continuous imaging or video capturing, are continuously performed, the focus driving may be performed during the exposure of the imaging element 20. As described above, in the rolling-shutter method, since the exposure period is different for each horizontal line, in a case in which the focus driving is performed during the exposure, the focus position is different for each horizontal line. This results in deterioration of image quality.

In order to suppress the image quality deterioration, it is conceivable to perform the focus driving in a non-exposure period from the end of the exposure to the start of the next exposure. However, in the continuous imaging or the video capturing at a high frame rate, the non-exposure period may not be obtained, and in this case, the focus driving cannot be performed, and the focus tracking cannot be performed on the subject that is an AF target. The technology of the present disclosure performs the focus driving while keeping, to a minimum, the image quality deterioration due to the focus driving in a case in which the plurality of imaging operations are continuously performed.

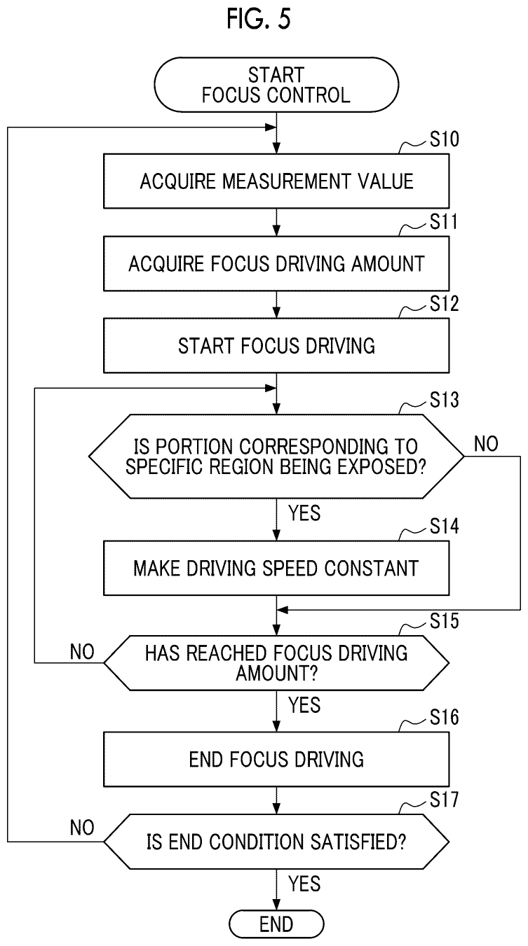

FIG. 5 shows an example of a flow of the focus control performed by the main controller 50. FIG. 5 shows a case in which the AF mode is set in the continuous imaging mode or the video capturing mode.

The main controller 50 acquires the distance measurement value generated by the distance measurement unit 55 performing the distance measurement based on the captured image PD output from the imaging element 20 by performing the imaging operation via the imaging element 20 (step S10). Specifically, the main controller 50 acquires the distance measurement value output from the distance measurement unit 55 for each vertical synchronization period (1V).

Next, the main controller 50 acquires the focus driving amount by predicting the distance to the subject after a predetermined time based on a plurality of distance measurement values acquired in the past (step S11). The focus driving amount is an amount of movement from a current position of the focus lens 31 required to bring the subject that is the AF target into focus after the predetermined time.

Next, the main controller 50 starts the focus driving (step S12). Specifically, the main controller 50 moves the focus lens 31 in a direction in which the subject that is the AF target is in focus at a focus driving speed corresponding to the focus driving amount. The focus driving speed is a movement speed of the focus lens 31 in a case in which the focus lens 31 is driven.

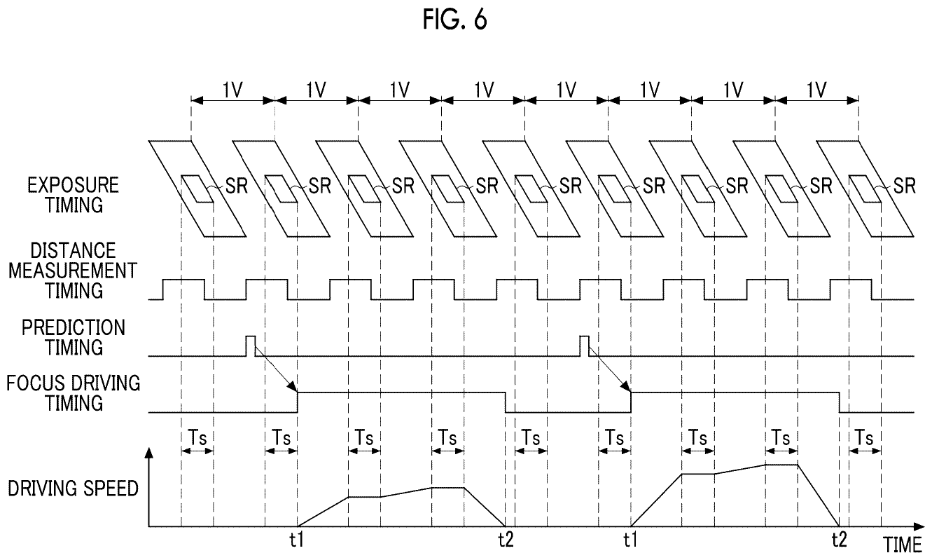

Next, the main controller 50 determines whether or not a portion SR (see FIG. 6) of the imaging element 20 corresponding to the AF area 60, which is an example of the specific region, is performing exposed (step S13). Specifically, the portion SR is a region corresponding to the AF area 60 (specific region) in the light-receiving surface 20A.

In a case in which the portion SR of the imaging element 20 is not undergoing the exposure (step S13: NO), the main controller 50 advances the processing to step S15. On the other hand, in a case in which the portion SR of the imaging element 20 is undergoing the exposure (step S13: YES), the main controller 50 makes the focus driving speed constant (step S14). Making the focus driving speed constant means keeping a rate of change in the movement speed of the focus lens 31 within a certain range. As described above, in a case in which the portion SR of the imaging element 20 corresponding to the specific region in the captured image PD is exposed, the control of making the focus driving speed constant corresponds to “first control” according to the technology of the present disclosure.

Then, the main controller 50 determines whether or not the movement amount of the focus lens 31 has reached the focus driving amount acquired in step S11 (step S15). In a case in which the movement amount of the focus lens 31 has not reached the focus driving amount (step S15: NO), the main controller 50 returns the processing to step S13 and continues the focus driving. On the other hand, in a case in which the movement amount of the focus lens 31 has reached the focus driving amount (step S15: YES), the main controller 50 ends the focus driving (step S16).

Next, the main controller 50 determines whether or not an end condition is satisfied (step S17). For example, the end condition is that the mode is switched, and in a case in which the mode is switched, the end condition is satisfied. In a case in which the end condition is not satisfied (step S17: NO), the main controller 50 returns the processing to step S10. On the other hand, in a case in which the end condition is satisfied (step S17: YES), the main controller 50 ends the processing.

FIG. 6 shows an example of various timings related to the focus control. As shown in FIG. 6, in the present embodiment, the imaging element 20 undergoes the exposure a plurality of times in accordance with one imaging instruction, and the main controller 50 performs the focus driving over a period during which the exposure is performed the plurality of times.

As shown in FIG. 6, the exposure timing shifts for each horizontal line. The exposure is performed for each vertical synchronization period (1V). A prediction timing is a timing at which the focus driving amount is acquired by predicting the distance to the subject after the predetermined time. FIG. 6 shows an example in which the distance to the subject after three vertical synchronization periods (3V) is predicted.

In the example shown in FIG. 6, the main controller 50 makes the focus driving speed constant in a period Ts during which the portion SR of the imaging element 20 corresponding to the specific region is exposed and changes the focus driving speed in other periods, between a time t1 at which the focus driving is started and a time t2 at which the focus driving ends. The main controller 50 need only make the focus driving speed constant at least in the period Ts, and may also make the focus driving speed constant in other periods.

In addition, in the example shown in FIG. 6, a timing and a length of the period Ts are constant, but the timing or the length of the period Ts may be changed. For example, in a case in which a position or a size of the AF area 60 is changed, a position or a size of the portion SR of the imaging element 20 corresponding to the specific region is changed, and the timing or the length of the period Ts is changed accordingly.

As described above, in the present embodiment, in a case in which the portion SR of the imaging element 20 corresponding to the specific region in the captured image PD is exposed, the first control of making the focus driving speed constant is performed, the image quality deterioration of the specific region having a high degree of importance in the captured image PD is suppressed. As a result, the image quality deterioration of the captured image PD is kept to a minimum. That is, according to the present embodiment, in a case in which the plurality of imaging operations are continuously performed, the focus driving can be performed while keeping, to a minimum, the image quality deterioration due to the focus driving.

### Second Embodiment

Hereinafter, a second embodiment of the present disclosure will be described. In the present embodiment, only the focus control performed by the main controller 50 is different from that of the first embodiment.

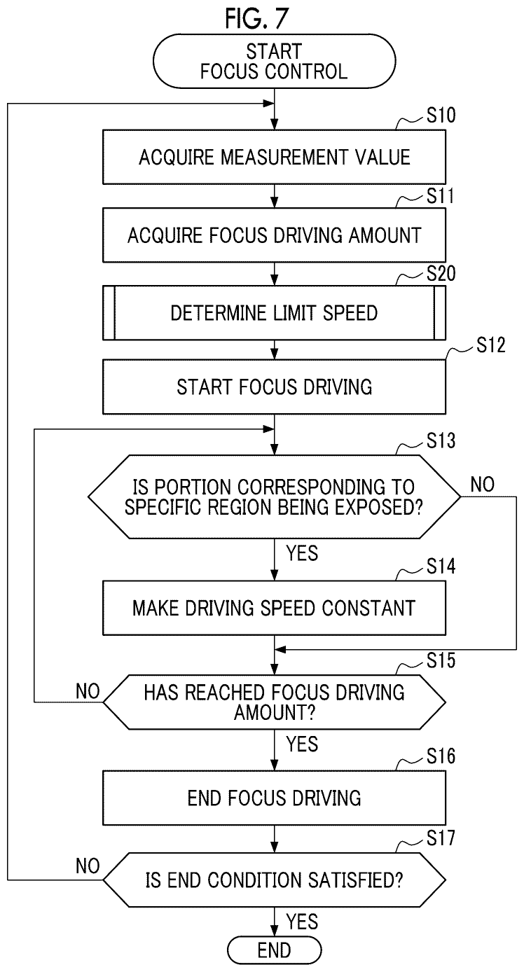

FIG. 7 shows an example of a flow of the focus control performed by the main controller 50 according to the second embodiment. FIG. 7 shows a case in which the AF mode is set in the continuous imaging mode or the video capturing mode.

The focus control according to the present embodiment is the same as the focus control according to the first embodiment except that step S20 is added between step S11 and step S12 and the processing content of step S14 is different.

In the present embodiment, the main controller 50 determines a limit speed based on the acquired focus driving amount after acquiring the focus driving amount in step S11 (step S20). In addition, in the present embodiment, the main controller 50 sets the focus driving speed to be equal to or less than the limit speed in step S14. That is, in the present embodiment, the main controller 50 executes second control of limiting the focus driving speed to be equal to or less than a predetermined speed, instead of the first control described in the first embodiment. The predetermined speed corresponds to the limit speed determined in step S20.

Even in a case in which the focus driving amounts are the same, a change amount of the depth of field varies in accordance with a subject distance at the current point in time. The subject distance refers to the distance from the imaging element 20 to the subject that is the AF target. The depth of field has a characteristic that, as the subject distance increases, the depth of field increases and the rate of change thereof decreases. Since the image quality is greatly deteriorated in a case in which the depth of field is greatly changed during the focus driving, in the present embodiment, the focus driving speed is limited based on the change amount of the depth of field estimated by the focus driving.

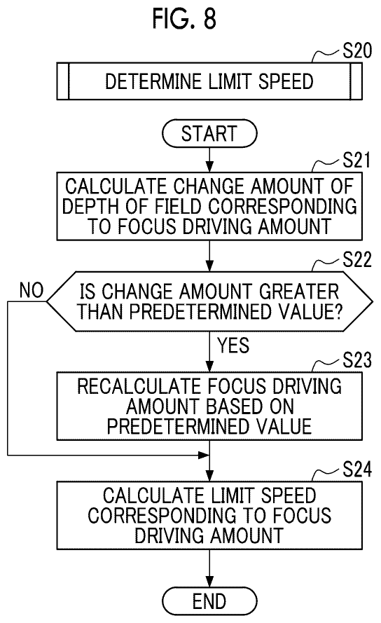

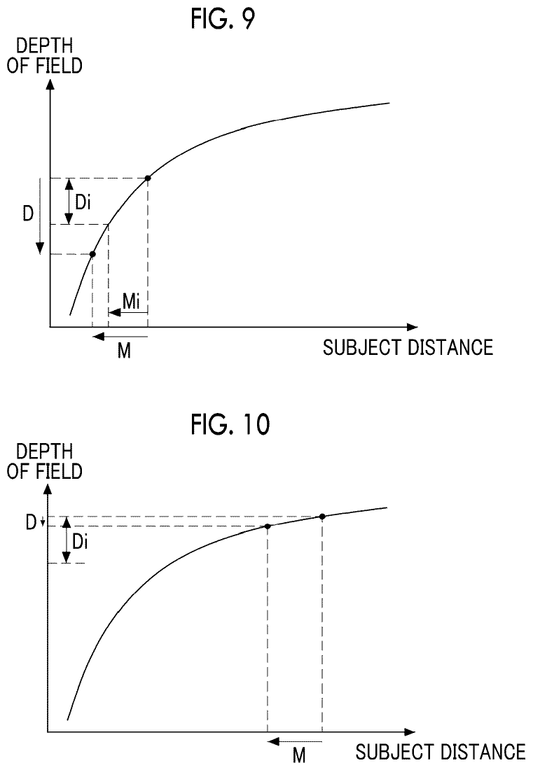

FIG. 8 shows an example of a flow of the processing (step S20) of determining the limit speed. The main controller 50 calculates a change amount D of the depth of field corresponding to the focus driving amount acquired in step S11 (step S21). For example, the main controller 50 calculates the change amount D of the depth of field corresponding to the focus driving amount (corresponding to a change amount M of the subject distance shown in FIGS. 9 and 10) based on data representing a relationship between the depth of field and the subject distance (see FIGS. 9 and 10) stored in advance in the memory 42.

Next, the main controller 50 determines whether or not the change amount D calculated in step S21 is greater than a predetermined value Di (step S22). For example, the predetermined value Di is a change amount of the depth of field allowed in the focus driving period (period from t1 to t2). Specifically, the predetermined value Di is a value representing the multiple of the current depth of field that is allowed.

In a case in which the change amount D is equal to or less than the predetermined value Di (NO in step S22), the main controller 50 advances the processing to step S24. On the other hand, in a case in which the change amount D is greater than the predetermined value Di (YES in step S22), the focus driving amount is recalculated based on the predetermined value Di (step S23). Specifically, the main controller 50 calculates the focus driving amount corresponding to a change amount Mi (see FIG. 9) of the subject distance at which the change amount of the depth of field from the current point in time is the predetermined value Di.

Next, the main controller 50 calculates the limit speed corresponding to the focus driving amount (recalculated focus driving amount in a case in which the recalculation is performed in step S23) (step S24). The limit speed is a focus speed in a case in which the focus driving is performed by the focus driving amount, and increases as the focus driving amount increases.

FIG. 9 shows an example of the change amount D of the depth of field in a case in which the subject distance is short. In the example shown in FIG. 9, since D>Di, the focus driving amount is recalculated based on the change amount Mi of the subject distance corresponding to the predetermined value Di.

FIG. 10 shows an example of the change amount D of the depth of field in a case in which the subject distance is large. In the example shown in FIG. 10, since D<Di, the focus driving amount is not recalculated. The focus driving amount is a value corresponding to the change amount M of the subject distance.

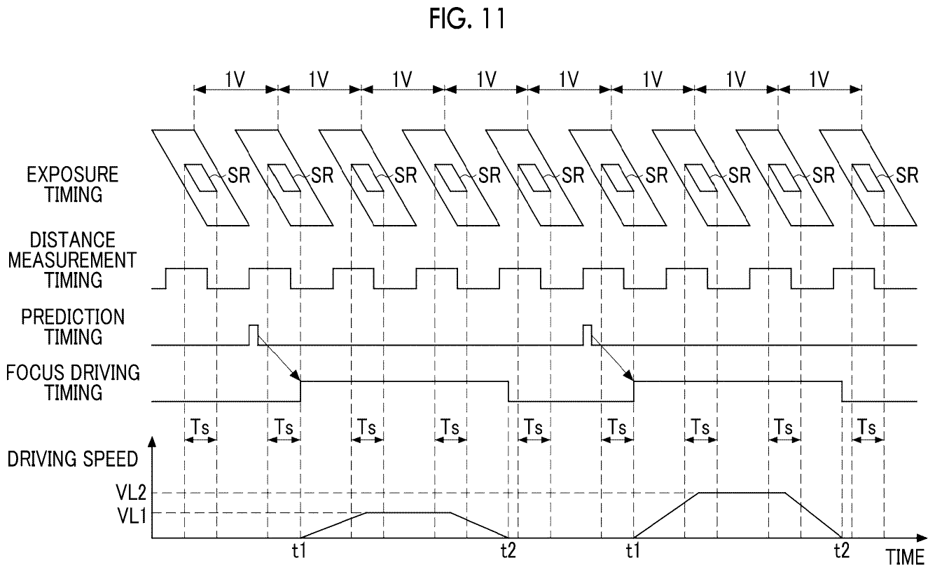

FIG. 11 shows an example of various timings related to the focus control according to the second embodiment. In the present embodiment, the focus driving speed is limited to be equal to or less than the limit speed in the period Ts during which the portion SR of the imaging element 20 corresponding to the specific region is exposed. Each of VL1 and VL2 is an example of the limit speed. For example, VL1 is the limit speed in a case in which D>Di, and VL2 is the limit speed in a case in which D<Di.

The main controller 50 need only limit the focus driving speed to be equal to or less than the limit speed at least in the period Ts, and the focus driving speed may be set to be greater than the limit speed in the other period.

### Third Embodiment

Hereinafter, a third embodiment of the present disclosure will be described. The present embodiment is different from the first embodiment or the second embodiment in that the main controller 50 executes third control of performing the focus driving in a non-exposure period obtained by shifting the exposure timing, in addition to the first control described in the first embodiment or the second control described in the second embodiment.

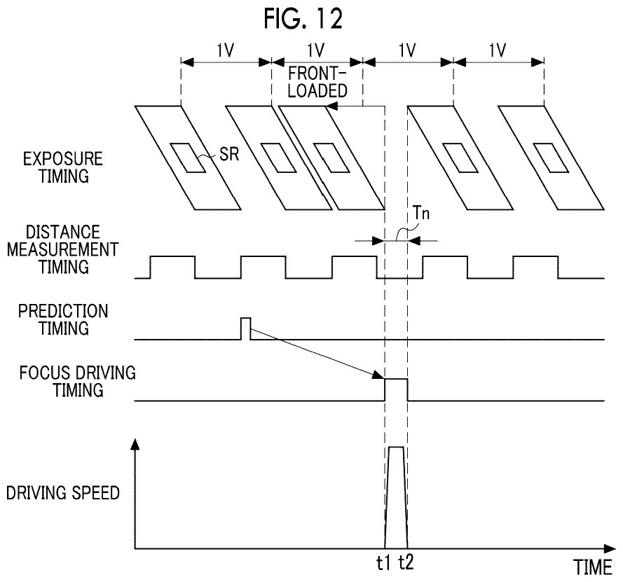

FIG. 12 shows an example of various timings in the third control. The imaging element 20 basically undergoes the exposure in a so-called “rear-loaded” mode, in which the exposure period is placed at the end side of one vertical synchronization period (1 V). As shown in FIG. 12, in the third control, the main controller 50 sets certain exposure periods to the start side of one vertical synchronization period (1 V), in a so-called “front-loaded” mode, to ensure a non-exposure period Tn during which none of the horizontal lines of the imaging element 20 is exposed, and performs the focus driving in the non-exposure period Tn. In this case, the main controller 50 performs the focus driving at a high speed without limiting the focus driving speed. Here, the high speed means a speed greater than the above-described limit speed.

In the present embodiment, in a case in which the acquired focus driving amount is large, the main controller 50 executes the third control in addition to the first control or the second control. Therefore, even in a case in which the focus driving amount is large, the focus driving can be performed in a short time, and the image quality deterioration can be further suppressed.

### Other Modification Examples

In each of the above-described embodiments, the AF area 60 is the specific region, but the specific region may be a region other than the AF area 60. The specific region may be, for example, a region including a specific subject detected by the subject detection.

In each of the above-described embodiments, the main controller 50 in the body 11 performs the focus control, but the lens drive unit 34 in the imaging lens 12 may perform the focus control. That is, the focus control device according to the technology of the present disclosure may be provided in any of the body 11 or the imaging lens 12.

The technology of the present disclosure is not limited to the digital camera, and can also be applied to electronic devices such as a smartphone and a tablet terminal having an imaging function.

In each of the above-described embodiments, each processing is executed by any computer. Further, any computer may execute these processes by a processor as hardware, a program as software, or a combination thereof. In such a case, the processor is configured to execute various types of processing in each of the above-described embodiments in cooperation with the program, and may function as each unit or each means in each of the above-described embodiments. Furthermore, the execution order of the processing by the processor is not limited to the above-described order and may be changed as appropriate. Any computer may be a general-purpose computer, a computer for specific use, a workstation, or another system that can execute each processing.

The processor may be configured by one or a plurality of types of hardware, and the type of hardware is not limited. For example, the processor may be configured by a central processing unit (CPU), a micro processing unit (MPU), a programmable logic device such as a field programmable gate array (FPGA), a dedicated circuit for executing specific processing, such as an application specific integrated circuit (ASIC), or hardware such as a graphic processing unit (GPU) or a neural processing unit (NPU). Moreover, the types of hardware may be a combination of different types of hardware. In a case in which the plurality of types of hardware are configured to execute one or a plurality of types of processing of a certain processor, the plurality of types of hardware may exist in devices physically separated from each other or may exist in the same device. Further, in any of the embodiments, the order of each processing performed by the processor is not limited to the above-described order, and may be changed as appropriate. The hardware is configured by an electric circuit (circuitry) in which circuit elements, such as semiconductor elements, are combined.

Furthermore, the program may be software such as firmware or a microcode. Furthermore, the program may be, for example, a program module group, and each function thereof may be implemented by a processor configured to execute each function. The program may be a program code or a plurality of code segments stored in one or a plurality of non-transitory computer-readable media (for example, a storage medium and other storages). The program may be stored in the plurality of non-transitory computer-readable media existing in physically separated devices. The program code or the code segment may represent any combination of procedures, functions, subprograms, routines, subroutines, modules, software packages, classes, instructions, data structures, or program statements. The program code or the code segment may be connected to another code segment or a hardware circuit by transmitting and receiving information, data, arguments, parameters, or contents of the memory.

Although, in each of the above-described embodiments, the aspect has been described in which the program 43 is prestored (installed) in the memory 42, the present disclosure is not limited thereto. The program 43 may be provided in a form of being recorded on a recording medium, such as a compact disc read-only memory (CD-ROM), a digital versatile disc read-only memory (DVD-ROM), or a universal serial bus (USB) memory. In addition, the program 43 may be downloaded from an external device via a network.

The technology of the present disclosure extends to any program products. The program products include products in any aspect for providing a program. For example, the program product includes a program provided through a network such as the Internet, and non-transitory computer-readable recording media such as a CD-ROM, a DVD, and a USB memory in which the program is stored.

The following technology can be understood based on the above description.

### Supplementary Note 1

A focus control device comprising: a processor, in which the processor is configured to execute, in a case in which a portion of an imaging element corresponding to a specific region in a captured image is exposed, at least one of first control of making a focus driving speed constant or second control of limiting the focus driving speed to be equal to or less than a predetermined speed.

### Supplementary Note 2

The focus control device according to supplementary note 1, in which the imaging element undergoes exposure using a rolling-shutter method.

### Supplementary Note 3

The focus control device according to supplementary note 2, in which the imaging element undergoes the exposure a plurality of times in response to one imaging instruction.

### Supplementary Note 4

The focus control device according to supplementary note 3, in which the processor is configured to perform focus driving over a period during which the exposure is performed the plurality of times.

### Supplementary Note 5

The focus control device according to any one of supplementary notes 1 to 4, in which the processor is configured to acquire a focus driving amount, and execute the second control in a case in which a change amount of a depth of field corresponding to the acquired focus driving amount is greater than a predetermined value.

### Supplementary Note 6

The focus control device according to supplementary note 5, in which the predetermined speed is a focus driving speed in a case in which focus driving is performed by a focus driving amount corresponding to the predetermined value.

### Supplementary Note 7

The focus control device according to supplementary note 5 or 6, in which the imaging element includes a plurality of phase-difference detection pixels, and the processor is configured to calculate the focus driving amount based on a defocus amount obtained based on output values of the plurality of phase-difference detection pixels.

### Supplementary Note 8

The focus control device according to any one of supplementary notes 1 to 7, in which the processor is configured to execute, in addition to the first control or the second control, third control of performing focus driving in a non-exposure period obtained by shifting an exposure timing.

### Supplementary Note 9

The focus control device according to supplementary note 8, in which the processor is configured to perform, in the third control, the focus driving at a focus driving speed greater than the predetermined speed.

### Supplementary Note 10

The focus control device according to any one of supplementary notes 1 to 9, in which the specific region is a focus target region.

### Supplementary Note 11

The focus control device according to any one of supplementary notes 1 to 9, in which the specific region is a region including a specific subject.

What is claimed is:

1. A focus control device comprising:
a processor,
wherein the processor is configured to execute, in a case in which a portion of an imaging element corresponding to a specific region in a captured image is exposed, at least one of first control of making a focus driving speed constant or second control of limiting the focus driving speed to be equal to or less than a predetermined speed.

2. The focus control device according to claim 1,
wherein the imaging element undergoes exposure using a rolling-shutter method.

3. The focus control device according to claim 2,
wherein the imaging element undergoes the exposure a plurality of times in response to one imaging instruction.

4. The focus control device according to claim 3,
wherein the processor is configured to perform focus driving over a period during which the exposure is performed the plurality of times.

5. The focus control device according to claim 1,
wherein the processor is configured to
acquire a focus driving amount, and
execute the second control in a case in which a change amount of a depth of field corresponding to the acquired focus driving amount is greater than a predetermined value.

6. The focus control device according to claim 5,
wherein the predetermined speed is a focus driving speed in a case in which focus driving is performed by a focus driving amount corresponding to the predetermined value.

7. The focus control device according to claim 5,
wherein the imaging element includes a plurality of phase-difference detection pixels, and
the processor is configured to calculate the focus driving amount based on a defocus amount obtained based on output values of the plurality of phase-difference detection pixels.

8. The focus control device according to claim 1,
wherein the processor is configured to execute, in addition to the first control or the second control, third control of performing focus driving in a non-exposure period obtained by shifting an exposure timing.

9. The focus control device according to claim 8,
wherein the processor is configured to perform, in the third control, the focus driving at a focus driving speed greater than the predetermined speed.

10. The focus control device according to claim 1,
wherein the specific region is a focus target region.

11. The focus control device according to claim 1,
wherein the specific region is a region including a specific subject.

12. A focus control method executed by a processor, comprising:
executing, in a case in which a portion of an imaging element corresponding to a specific region in a captured image is exposed, at least one of first control of making a focus driving speed constant or second control of limiting the focus driving speed to be equal to or less than a predetermined speed.

13. A non-transitory computer-readable storage medium storing a program causing a processor to execute a process comprising:
executing, in a case in which a portion of an imaging element corresponding to a specific region in a captured image is exposed, at least one of first control of making a focus driving speed constant or second control of limiting the focus driving speed to be equal to or less than a predetermined speed.
